(19) United States
(12) Patent Application Publication
(10) Pub. No.: US 2019/0170017 A1
(43) Pub. Date: Jun. 6, 2019

(54) SUPPORTING DEVICE FOR A CASING OF A TURBOMACHINE, CASING FOR A TURBOMACHINE, AND TURBOMACHINE

(71) Applicant: MTU Aero Engines AG, Muenchen (DE)

(72) Inventors: Martin Metscher, Muenchen (DE); Jan Haegert, Gilching (DE)

(21) Appl. No.: 16/199,363

(22) Filed: Nov. 26, 2018

(30) Foreign Application Priority Data
Dec. 1, 2017 (DE) DE102017221669.7

(51) Int. Cl. F01D 25/28; F02C 7/20; F01D 25/24

(52) U.S. Cl. CPC F01D 25/28; F02C 7/20; F05D 2260/941; F05D 2220/32; F01D 25/24

(57) ABSTRACT

A supporting device (10) for a casing (12) of a turbomachine (100), for bracing against forces acting on the casing (12) that occur during operation of the turbomachine (100), having at least one hub element (40), and at least one supporting element (20) for holding the hub element (40) on the casing (12). The supporting device (10) includes at least one rotary joint (30) which is used to rotatably connect the hub element (40) to the supporting element (20). Other aspects of the present invention relate to a casing (12) for a turbomachine (100), and to a turbomachine (100).

This claims the benefit of German Patent Application DE102017221669.7, filed Dec. 1, 2017 and hereby incorporated by reference herein.

The present invention relates to a supporting device for a casing of a turbomachine, for bracing against forces acting on the casing that occur during operation of the turbomachine, including at least one hub element and at least one supporting element for holding the hub element on the casing. Other aspects of the present invention relate to a casing for a turbomachine, and to a turbomachine.

### BACKGROUND

The U.S. Patent Application 2017/0030223 A1 describes a gas turbine where a metallic structure is formed by a plurality of struts via which load is transmittable from a hub to a turbine casing of the gas turbine. The hub supports a rotor and transmits static and dynamic loads through the struts to the casing. The struts are formed in one piece with a surface of the hub and welded or brazed to the surface thereof, for example. A gas turbine of this type is also discussed in the British Patent Application GB 2 280 484 A.

### SUMMARY OF THE INVENTION

It is an object of the present invention to provide a supporting device, a casing, as well as a turbomachine of the type mentioned at the outset in a way that will make possible an especially beneficial load distribution of forces during operation of the turbomachine.

A first aspect of the present invention relates to a supporting device for a casing of a turbomachine, for bracing against forces acting on the casing that occur during operation of the turbomachine, including at least one hub element and at least one supporting element for holding the hub element on the casing. The hub element may have a rotationally symmetric configuration, at least in some regions, and, for example, have a periphery where the supporting element or a plurality of supporting elements may support the casing. The supporting element may have a casing-side element end where it is joined to the casing, preferably in a material-to-material bond, thus, for example, welded thereto.

In accordance with the present invention, the supporting device includes at least one rotary joint for rotatably connecting the hub element to the supporting element. This is advantageous since it is hereby possible to prevent bending moments, which may be induced by forces that occur during operation of the turbomachine, from being transmitted between the supporting element and the hub element. By preventing the transfer of bending moments, unacceptably high, bending moment-induced tensile stresses are able to be effectively prevented at a join region where the supporting element is connected to the hub element. Instead, an especially favorable load distribution and load application are achieved by using at least one rotary joint to connect the hub element to the supporting element.

During operation of the turbomachine, the at least one rotary joint makes possible an operationally induced displacement of the hub element, for example, along a central axis of a casing opening which extends through the casing. Since the rotary joint permits relative rotation between the hub element and the supporting element, a critical deformation may be prevented whereby the supporting element is subject to critical bending moment-induced stresses. Instead, the rotary joint promotes an uncritical deformation of the supporting element.

Thus, in contrast to a rigid connection, for example, in the form of a welded or brazed joint, between the supporting element and the hub element, the at least one rotary joint permits at least one relative rotation about at least one axis of rotation between the at least one hub element and the at least one supporting element in response to forces, in particular axial forces, acting on the at least one hub element during operation of the turbomachine. This makes possible an especially low-stress loading of the supporting device during operation of the turbomachine.

Another advantageous embodiment of the present invention provides that the at least one rotary joint be in the form of an articulated joint. This is advantageous since the articulated joint makes possible a controlled rotational movement (relative rotation) about an axis of rotation. Accordingly, the articulated joint makes possible an especially controlled load distribution, respectively load application of operationally induced forces.

In another advantageous embodiment of the present invention, the at least one rotary joint is in the form of a spherical joint. This is advantageous since the spherical joint makes possible a plurality of rotational movements about a plurality of axes of rotation. Accordingly, the spherical joint permits a plurality of rotational degrees of freedom, whereby it is possible to even completely prevent the transfer of bending moments resulting from operationally induced forces from the hub element to the supporting element. An especially low-stress load distribution is thereby made possible.

In another advantageous embodiment of the present invention, the at least one rotary joint has at least one joint element that is rotatably received in a recess of the at least one supporting element or of the at least one hub element. This is advantageous since the rotary joint hereby makes possible an especially space-saving coupling between the supporting element and the hub element. Another advantage is that the rotational positioning of the joint element in the recess not only makes possible a rotational motion between the supporting element and the hub element, but a pivoting angle between the supporting element and the hub element may also be limited very economically. This is because the joint element is received in the recess, allowing it at the same time to form a limit stop where it may be braced against a plurality of locations on the supporting element upon reaching a maximally permissible pivoting angle.

Another advantageous embodiment of the present invention provides that the at least one joint element be received form-fittingly in the recess of the at least one supporting element or of the at least one hub element. This is advantageous since an especially captive coupling between the joint element and the supporting element or the hub element is made possible by the form-fitting receiving. Moreover, the form-fitting receiving provides an especially loadable rotary connection, where an especially large-area force distribution may be implemented between the joint element and the supporting element.

In another advantageous embodiment of the present invention, the at least one supporting element is in the form of a strut. This is advantageous since such a strut has an especially simple design and makes it possible to support the hub element, respectively brace against operationally induced forces acting on the casing in the presence of an especially favorable force flow.

In another advantageous embodiment of the present invention, the at least one hub element has a passageway for receiving a shaft element, in particular a rotor shaft, of the turbomachine. This is advantageous since the hub element renders possible an especially favorable support of the shaft element, as well as a low-stress force flow of operationally induced forces between the shaft element and the casing.

The hub element may preferably be designed to at least indirectly support the shaft element. A bearing element, in the form of a rolling bearing, for example, mounted on the hub element, in particular fixed thereto, may provide an indirect supporting, for example. In the post-assembly position of the supporting device and thus during normal operational use thereof, the bearing element may be mounted, in particular fixed between the hub element and the shaft element.

A second aspect of the present invention relates to a casing for a turbomachine, having at least one supporting device in accordance with the first aspect of the present invention. A casing of this kind makes possible an especially favorable load distribution of forces during operation of the turbomachine.

In an advantageous embodiment of the present invention, the casing is designed as a turbine center frame. This is advantageous since the turbine center frame may constitute an especially favorable interface between a high-pressure turbine side and a low-pressure turbine side of the turbomachine. Hot gas having a temperature of more than 1000° C. may flow through the turbine center frame from the high-pressure turbine side to the low-pressure turbine side. Because of the favorable load distribution that is attainable using the supporting device, the turbine center frame that is equipped therewith, thus that includes the same, features an especially low-stress deformation behavior, even when hot gas having such a high temperature passes through the turbine center frame.

A third aspect of the present invention relates to a turbomachine, having at least a supporting device in accordance with the first aspect of the present invention and/or having a casing in accordance with the second aspect of the present invention. Working with a turbomachine of this kind makes possible an especially favorable load distribution of forces that occur during operation thereof.

In an advantageous embodiment of the present invention, the turbomachine is a gas turbine. A gas turbine is exceptionally efficient. Moreover, a gas turbine equipped with the supporting device features an especially favorable deformation behavior, even at high gas temperatures, respectively high operationally induced forces.

The explanations regarding one of the aspects of the present invention, in particular regarding individual features thereof, also apply analogously to the other aspects of the present invention.

Other features of the present invention will become apparent from the claims, the figures, and the detailed description. The features and feature combinations mentioned above in the description as well as the features and feature combinations mentioned below in the detailed description and/or shown in isolation in the figures may be used not only in the indicated combination, but also in other combinations without departing from the scope of the present invention. Thus, embodiments of the present invention that are not explicitly shown and described in the figures, but derive from and can be produced from the explained embodiments using separate feature combinations, are also considered to be included and disclosed herein. Embodiments and feature combinations are also considered to be disclosed herein that, therefore, do not include all of the features of an originally formulated independent claim. Moreover, variants and feature combinations are also considered to have been disclosed herein, in particular by the above explanations that go beyond or deviate from the feature combinations described.

### BRIEF DESCRIPTION OF THE DRAWINGS

In the drawing,

FIG. 1 shows a portion of a turbomachine;

FIG. 2 schematically illustrates a casing of the turbomachine, in some regions, as well as a supporting device attached to the casing in accordance with an area A shown in FIG. 1;

FIG. 3 is a schematic representation of a hub-strut connection known from the related art.

### DETAILED DESCRIPTION

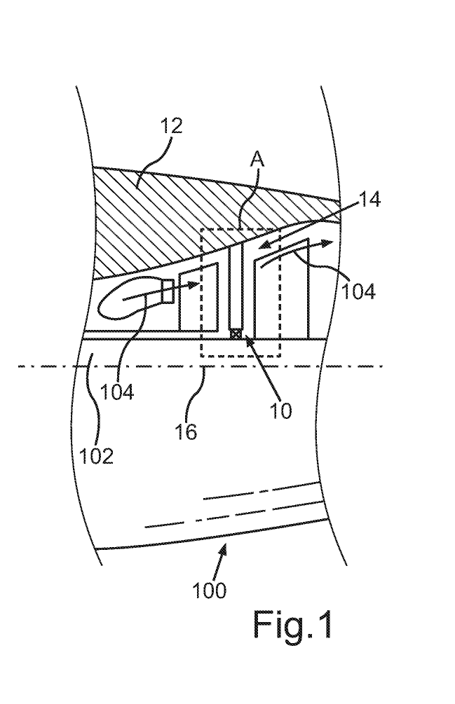

FIG. 1 shows a portion of a turbomachine 100 which is merely shown in some regions here and is in the form of a gas turbine. Turbomachine 100 includes a casing 12 which is designed here as a turbine center frame. During operation of turbomachine 100, a shaft element 102 of turbomachine 100 rotates within a casing opening 14 of casing 12. In addition, hot gas 104 flows through casing opening 14 of casing 12 and thereby from a high-pressure turbine side of turbomachine 100 to a low-pressure turbine side of turbomachine 100. In the present case, casing opening 14 is in the form of a channel-type passageway.

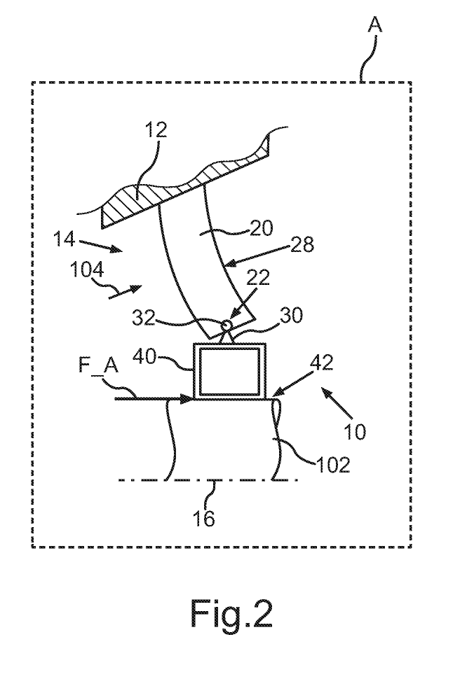

FIG. 2 schematically depicts some regions of a portion of casing 12 in accordance with an outlined area A shown in FIG. 1, a supporting device 10 being mounted in passageway 14 of casing 12. Supporting device 10 is used for bracing against forces that occur during operation of turbomachine 100, such as, for example, an axial force F_A that acts on casing 12 illustrated by an arrow in FIG. 2. Supporting device 10 includes a hub element 40, upon which axial force F_A acts in the present case.

Moreover, supporting device 10 includes a plurality of supporting elements in the form of respective struts, of which only one single supporting element 20 is shown in the present case. The supporting elements may, for example, each be joined in a material-to-material bond to casing 12, thus, for example, welded thereto. Supporting element 20, in the form of a strut, is used for holding hub element 40 on casing 12. The following explanations that relate to supporting element 20 also apply analogously to the further supporting elements, which are not shown in FIG. 2, are disposed circumferentially along casing 12 in casing opening 14, and are each rotatably connected to hub element 40.

Hub element 40 has a passageway 42 for receiving shaft element 102 which, in the present case, is in the form of the rotor shaft of turbomachine 100. Axial force F_A may occur, for example, in response to temperature-induced changes in the length of shaft element 102, to name just one example.

Supporting device 10 includes a plurality of rotary joints, each one of which is connected to a respective supporting element, as well as to hub element 40. In the present case, FIG. 2 shows only one single rotary joint 30. Rotary joints rotatably connect hub element 40 to supporting element 20. In the present case, the rotary joints are in the form of respective articulated joints. Alternatively, the rotary joints could also be designed as respective spherical joints. The following explanations that relate to rotary joint 30 also apply analogously to the further rotary joints, which are not shown in FIG. 2 and are each coupled to hub element 40.

Rotary joint 30 may at least permit relative rotation between hub element 40 and supporting element 20 in response to axial force F_A acting on hub element 40.

During operation of turbomachine 100, rotary joint 30 (and thus all rotary joints) makes possible, for example, an operationally induced axial displacement of hub element 40, for example, along a central axis 16 of the casing opening which extends through casing 12 and in which supporting device 10 is mounted in the present case. This central axis 16 also corresponds here to an element central axis of hub element 40, as well as to a shaft axis of shaft element 102. A displacement of hub element 40 causes an uncritical deformation 28 in the form of an at least slight deflection of supporting element 20. Critical stresses are thereby at least largely prevented from occurring in supporting device 10 and, in particular, in supporting element 20.

Rotary joint 30 has a joint element 32 that is rotatably received in a recess 22 of supporting element 20. Alternatively, recess 22 could also be provided in hub element 40 and, correspondingly, joint element 32 be introduced into hub element 40. Joint element 32 is received form-fittingly in recess 22 of the at least one supporting element 20.

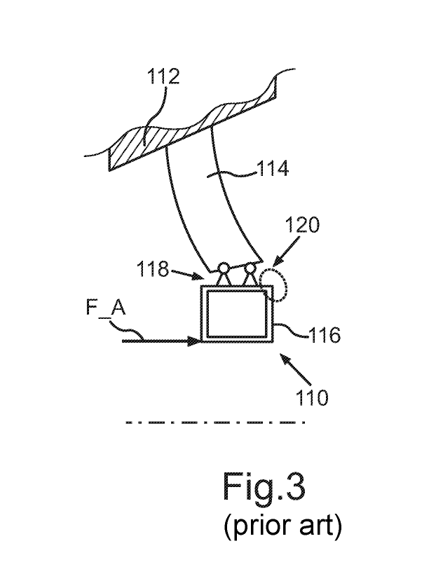

FIG. 3 shows a hub-strut connection 110 known from the related art that includes a strut 114 and a hub 116. Strut 114 and hub 116 are joined to one another rigidly, for example, by a welded connection, at a join region 118. Strut 114 is thereby welded to a casing component 112. Axial force F_A acting on hub 116 displaces the same, causing a critical stress region 120 to occur, as denoted in FIG. 3 by a dashed line, where unacceptably large stresses can take place. Moreover, an unfavorable, S-shaped deformation of torsionally rigid hub-strut connection 110 occurs in the area of strut 114, as can be inferred from FIG. 3.

In contrast, in the case of supporting device 10, the rotary joint ensures that no unfavorable stress region 120 shown in FIG. 3, nor S-shaped deformation occurs. Accordingly, the rotary joints also effectively prevent unacceptably high tensile stresses from occurring in supporting device 10. The rotary joints provide a respective point of articulation which makes possible a load-oriented stress distribution that is improved over hub-strut connection 110 known from the related art.

Since rotary joint 30 permits relative rotation between hub element 40 and supporting element 20, it is possible in other words to prevent the critical S-shaped deformation which leads to critical bending moment-induced stresses. Instead, rotary joint 30 promotes uncritical deformation 28 of respective supporting element 20. In the case of uncritical deformation 28, instead of the S-shaped deformation shown in FIG. 3, the result is that supporting element 20 is merely deflected, as shown in FIG. 2.

### REFERENCE NUMERAL LIST

10 supporting device

12 casing

14 casing opening

16 central axis

20 supporting element

22 recess

28 deformation

30 rotary joint

32 joint element

40 hub element

42 passageway

100 turbomachine

102 shaft element

104 hot gas

110 hub-strut connection

112 casing component

114 strut

116 hub

118 join region

120 stress region

F_A axial force

1-11. (canceled)

12. A supporting device for a casing of a turbomachine, for bracing against forces acting on the casing that occur during operation of the turbomachine, the supporting device comprising:
at least one hub element;
at least one support element for holding the hub element on the casing; and
at least one rotary joint rotatably connecting the hub element to the supporting element.

13. The supporting device as recited in claim 12 wherein the at least one rotary joint is an articulated joint.

14. The supporting device as recited in claim 12 wherein the at least one rotary joint is in the form of a spherical joint.

15. The supporting device as recited in claim 12 wherein the at least one rotary joint has at least one joint element rotatably received in a recess of the at least one support element or of the at least one hub element.

16. The supporting device as recited in claim 15 wherein the at least one joint element is received form-fittingly in the recess of the at least one support element or of the at least one hub element.

17. The supporting device as recited in claim 12 wherein the at least one support element is a strut.

18. The supporting device as recited in claim 12 wherein the at least one hub element has a passageway for receiving a shaft element.

19. The supporting device as recited in claim 12 wherein the at least one hub element has a passageway for receiving a rotor shaft of the turbomachine.

20. A casing for a turbomachine comprising at least one supporting device as recited in claim 12.

21. The casing as recited in claim 20 wherein the casing is a turbine center frame.

22. A turbomachine comprising at least one supporting device as recited in claim 12.

23. The turbomachine as recited in claim 22 wherein the turbomachine is a gas turbine.
